(19) United States
(12) Patent Application Publication
(10) Pub. No.: US 2005/0026008 A1
(43) Pub. Date: Feb. 3, 2005

(54) Method for processing stack gas emissions

(75) Inventors: Harley L. Heaton, Manassas, VA (US); Robin Z. Parker, Miami, FL (US); Melahn L. Parker, Miami, FL (US); Jimmy B. Keller, Golden, CO (US); Bruce A. Salisbury, Farmington, NM (US)

Correspondence Address: PILLSBURY WINTHROP, LLP, P.O. BOX 10500, MCLEAN, VA, 22102, US

(73) Assignee: Solar Reactor Technologies Inc., Miami, FL (US)

(21) Appl. No.: 10/860,658

(22) Filed: Jun. 4, 2004

Related U.S. Application Data
(60) Provisional application No. 60/475,791, filed on Jun. 5, 2003.

(51) Int. Cl. H01M 8/18

(52) U.S. Cl. 429/17; 429/21

(57) ABSTRACT

Apparatus and methods for augmenting the Mark 13a process of Van Zelzen et al., by providing for the addition of dispatchable energy storage and/or additional waste stream treatments. Sulfur-containing stack gas emissions from the burning of fossil fuels for electricity production are cleaned, removing the sulfur by use of the Bunsen reaction. The process produces hydrogen and sulfuric acid as byproducts. The hydrogen output of the process can be used to co-produce electricity in a reversible fuel cell, and optionally can be stored so that electricity can be produced during periods of high demand. Optionally the hydrogen can be reacted with air-nitrogen or nitrogen from the combustion gasses to produce ammonia. The sulfuric acid can optionally be reacted with iron or aluminum to produce iron or aluminum sulphates and additional electricity. In addition, mercury removal from the gas emissions from burning fossil fuels (primarily coal) can be performed.

This application claims priority to U.S. Provisional Patent Application No. 60/475,791 by Heaton et al., filed Jun. 5, 2003.

The invention described herein was made with support of the United States Government and the Government has certain rights in the invention.

### BACKGROUND OF THE INVENTION

1. Field of the Invention

The present invention relates generally to methods and apparatus for treatment of fluids and more particularly for sulfur removal from fluids.

2. Description of Related Art

In a typical fossil fuel utility plant, fossil fuel is burned using combustion air, and cooling water, to provide electric power, and, as byproducts, process heat and ‘dirty’ stack gas which typically includes CO₂, SO₂, NO_{X}, H₂O, N₂ and O₂. Many electric power generating plants are equipped to clean stack gases, and to recover at least some of the process heat. Where the market for electric power which could be served from the plant varies, e.g., by time of day or seasonally, it has become typical to design and operate the plant to produce some fraction below 100%, of the marketable power which is neither as small as the minimum load that the system depending on the plant ever experiences, nor as much large as the maximum load experienced, or, with projected growth, could be expected to be experienced in that system.

For dealing with the variable load that is above or below that fraction, different electric power providers employ different strategies. One is to operate additional electric power generating equipment (e.g., additional turbine-powered generators) only during peak load periods. That solution may require considerable capital investment in facilities that are not always in use. Another strategy, is to buy power generated by others, and selling to others excess power. This strategy depends in part on peak loading being out of phase from one generating plant to another. Yet another strategy is pumped storage or some conceptually similar way of putting aside for use during a time of greater demand, some of the electric power that is generated during a time of lesser demand, and vice versa. In that sense, a fossil fueled electric power generating plant and its distribution system, considered as a whole, can be considered to produce excess off-peak electric power, and to have a capability to consume on-peak electric power.

### BRIEF DESCRIPTION OF THE DRAWINGS

The present invention will be understood by reference to the following drawing figures, in which:

FIG. 1 is a schematic view of a multiple stage reactor/gas washing apparatus suitable for a process in accordance with embodiments of the present invention;

FIG. 2 is a schematic view of a distillation apparatus adapted to separate the components of the sump liquid of the apparatus of FIG. 1;

FIG. 3 is a schematic view of a multiple stage reactor/gas washing apparatus with a distillation apparatus, electrical load leveling, and hydrogen generation components, in accordance with embodiments of the present invention;

FIG. 4 is a schematic view of a process in accordance with embodiments of the present invention using a hydrogen bromide electrolyzer;

FIG. 5 is a schematic view of a hydrogen bromide electrolyzer;

FIG. 6 is a schematic view of a reversible hydrogen bromide electrolyzer/fuel cell according to one embodiment of the present invention; and

FIG. 7 is a schematic view of a reversible hydrogen bromide electrolyzer/fuel cell according to another embodiment of the present invention.

### DETAILED DESCRIPTION OF EMBODIMENTS OF THE INVENTION

Embodiments of the present invention can be used in conjunction with one or more fossil fueled electric power generating plants. Where, in the text and drawings, a ‘utility plant’ is mentioned, that mention is meant to encompass both an arrangement concerned with one fossil fueled electric power generating plant, and an arrangement in which a plurality of such plants are involved.

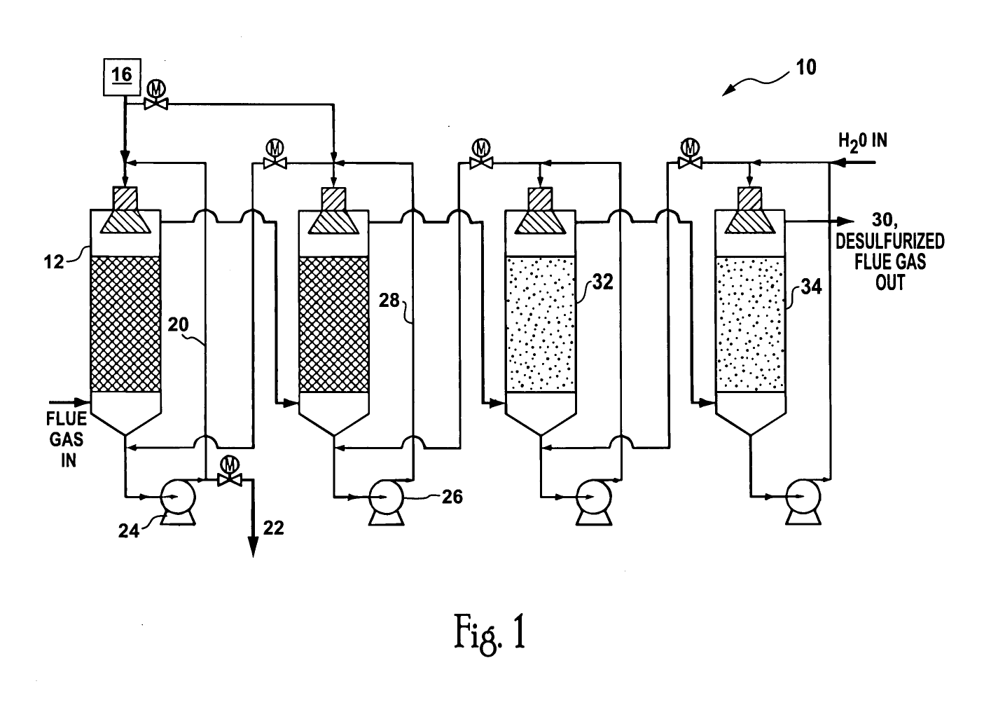

In a stack gas cleaning process, dirty stack gas from the fossil fueled utility plant, previously cooled by heat exchangers or other structures to approximately 100° C., is directed to the first stage of a multiple stage reactor/gas washing apparatus as shown generally at 10 in FIG. 1. Each stage consists of apparatus for introducing the stack gas stream, later venting the stream, and passing it through a reaction volume. For example, the reaction volume may be a column of glass helices, several raschig rings, or other shapes constructed of glass, ceramic or otherwise appropriate material, designed to furnish a large surface area whereby the gas can flow over and around a reactant/washing material, for example liquid surface films of a reactant/washing solution. In the first 12 and second 14 stages (or optionally, more stages if required or only one stage, if preferred) of this apparatus, a reactant halogen material, for example bromine liquid or gas is introduced to the column. In the illustrated example, the reactant is introduced from a supply 16 to an inlet at the top of the column. A metering valve 18 may be included to control flow into one or both of the stages 12, 14. Furthermore, each column can be bathed with a liquid solution, most of which can be pumped from a sump at the bottom of the column to a spray head at the top. Thus, in traversing the packing, the gas is extensively contacted with an aqueous solution that contains the reaction material, in the case of the first two or three columns.

In these same columns the SO₂ from the incoming dirty stack gas is converted to HBr according to the following reaction:
Br₂+SO₂+H₂O=>HBr+H₂SO₄

This has been described in the literature as the Bunsen reaction. In its more general form, for any halogen X, it can be expressed as:
X₂+SO₂+H₂O=>HX+H₂SO₄ or, in balanced form:
X₂+SO₂+2H₂O=>2HX+H₂SO₄

For the remainder of the description, the bromine reaction is described, but the present invention is not restricted to the use of bromine.

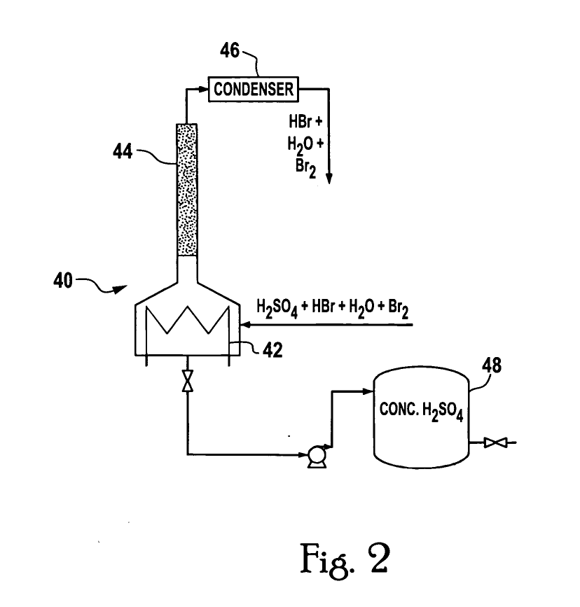

As a result of this reaction, the liquid collecting in the sump of the first column, after a period of operation, is a moderately concentrated mixture of aqueous H₂SO₄ in HBr, containing also traces of bromine. A portion of the liquid is recirculated and the remainder is output as processed liquid. As an example, in the illustrated embodiment, approximately 90% of the liquid in the sump can be drawn off for recirculation through the spray head at the top via conduit 20, while 10% is output through output 22 to a separate apparatus (item 40 of FIG. 2, discussed below) where H₂SO₄ is concentrated, and a mixture of water, HBr, and Br₂ is driven off. The product HBr (containing a little excess Br₂) of the second apparatus can then be returned to the concentration control/distillation subunit of the second stage 14, described above. As necessary, a pump 24 is used to pressurize the fluid such that it flows through the recirculation loop 20 or to the output 22.

The stack gas exiting the first stage 12 enters the second stage 14 where it is again bathed in a solution recirculated by a pump from the sump at the bottom by a second recirculation loop 28. In this reactor 14, and in additional secondary reactors (not shown), if desired, additional amounts of Br₂ from the supply 16 can be added to remove any remaining SO₂ via the previously mentioned reaction. A portion of the liquid can be recirculated in the second stage 14 to the spray head at the top, while the remaining portion may directed to mingle with the fluid entering the spray at the top of stage 12. As in the first stage 12, a 90/10 proportion of recirculated fluid to output fluid may be used. Alternately, the output fluid could be output as in the first stage, however, in general, this fluid will not be as highly concentrated in the desirable H₂SO₄, HBr, and Br₂ components, and therefore the secondary distilling process is not as valuable when performed on this material.

In certain circumstances, it is desirable to provide real time spectrophotometric analysis for Br₂ vapor in the second stage 14 (and the additional reactor, if provided), using a simple filter spectrometer. The amount of bromine added to the second stage 14 (and optionally, in the third reactor, if provided) is monitored so as to quantitatively consume as much of the remaining SO₂ as is practical.

After the reactions in stages 12 and 14, the partially processed stack gas is further cleaned using a water-based acid scrubbing process in a pair of acid scrubbers 32, 34.

The bromine reaction does not require an especially high temperature; about 100° C. is adequate in the first stage 12. Accordingly, the hot, dirty stack gas is initially cooled via a heat exchanger, simultaneously re-warming the N₂/CO₂ mixture which is sent onward to the exit stack to the atmosphere at 30.

As mentioned above, approximately ten percent of the liquid collecting in the sump of stage 12 is directed to a distillation apparatus for sulfuric acid purification. The sump liquid is a mixture of sulfuric acid, aqueous HBr, and bromine. These are conveniently separated by distillation in a distiller 40, as shown in FIG. 2. The distiller 40 includes a heating element 42 that acts to heat the mixture of fluids. Vapor from the heated fluids passes through the distillation column 44, to a condenser 46 where HBr, H₂O and Br₂ are removed as fluid. Meanwhile, the concentrated H₂SO₄ collects in a container 48 for later use or sale.

Depending upon requirements of the overall system, the mixture of aqueous HBr +Br₂ can be taken off at the still head, and clean, concentrated sulfuric acid can be taken from the distillation pot. Alternatively, if desired, by varying the distillation parameters, nearly pure Br₂ can be taken off at the still head, and a solution of HBr+Br₂ (containing also a small amount of Br₂) can be taken off at an intermediate point in the still.

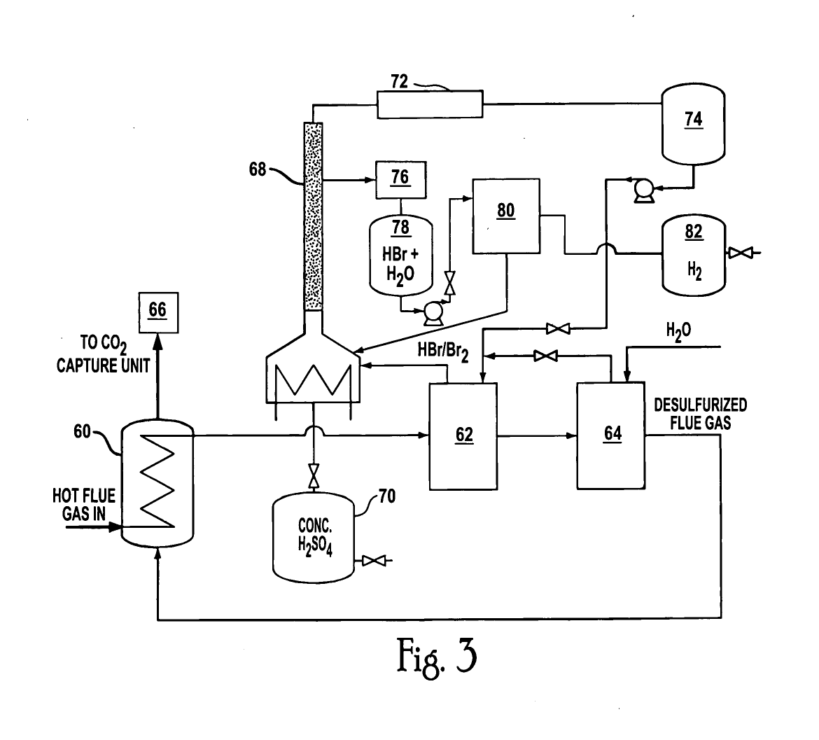

FIG. 3 shows integration of the SO₂-scrubbing equipment and sulfuric acid distillation apparatus of FIG. 2 with other components of the load leveling and hydrogen generation of FIG. 1. In the apparatus as shown in FIG. 3, hot flue gas enters via heat exchanger 60 and is directed toward a multi-stage reactor 62 (similar in operation to the two-stage reactor 12, 14 shown in FIG. 1). The multi-stage reactor 62 may be made, for example, of two or three stages as described above. The resulting flue gas, now substantially free of SO₂, is purified by water scrubbing at scrubber 64 (similar in operation to the scrubbers 32, 34 of FIG. 1). The resulting desulfurized flue gas is reheated by heat exchanger 60 and directed to the stack at 66.

The sulfuric acid produced by the reactor 62 is purified in distillation column 68, and the H₂SO₄ solution so produced is stored in a vessel 70. As previously mentioned, bromine can be separated at the top of the still, passing via a condenser 72 to a bromine storage vessel 74. HBr aqueous solution is obtained at a lower point in the still, cooled by condenser 76, and directed to storage vessel 78, from which it is pumped to a reversible fuel cell 80 for electrolysis of the HBr to bromine and production of H₂ (stored in a storage tank 82) for commercial sale or use in electricity production. Condensers 72 and 76 are shown separately for schematic clarity; in practice they may be integrated into the distillation apparatus 68.

Mercury is one of many trace elements released from coal during combustion. Once released, most elements in coal tend to exit with the ash left over from combustion and are not released freely into the environment. Mercury behaves differently, however, because it tends to stay in elemental form with the combustion gases. As a result, a large fraction of the mercury in coal can be released into the environment through a power plant's stack gases. Even though the amount of mercury in coal on a per pound basis is small, the total amount of mercury released in the United States is estimated to be about 43 tons per year. At present, the EPA does not regulate the emissions of mercury, but new EPA emission requirements may require utilities to reduce their Hg emissions by 50% in the coming years.

Mercury that remains in elemental form after combustion readily escapes typical flue gas desulfurization processes because of its inherently low solubility in water and relatively high vapor pressure. Although current post combustion treatments for SO₂ remove some mercury, it is likely that new methods will be needed to meet new EPA reduction targets of 50% or more. Because the concentration of mercury in flue gases is several orders of magnitude lower than SO₂, removing mercury can be projected to be expensive.

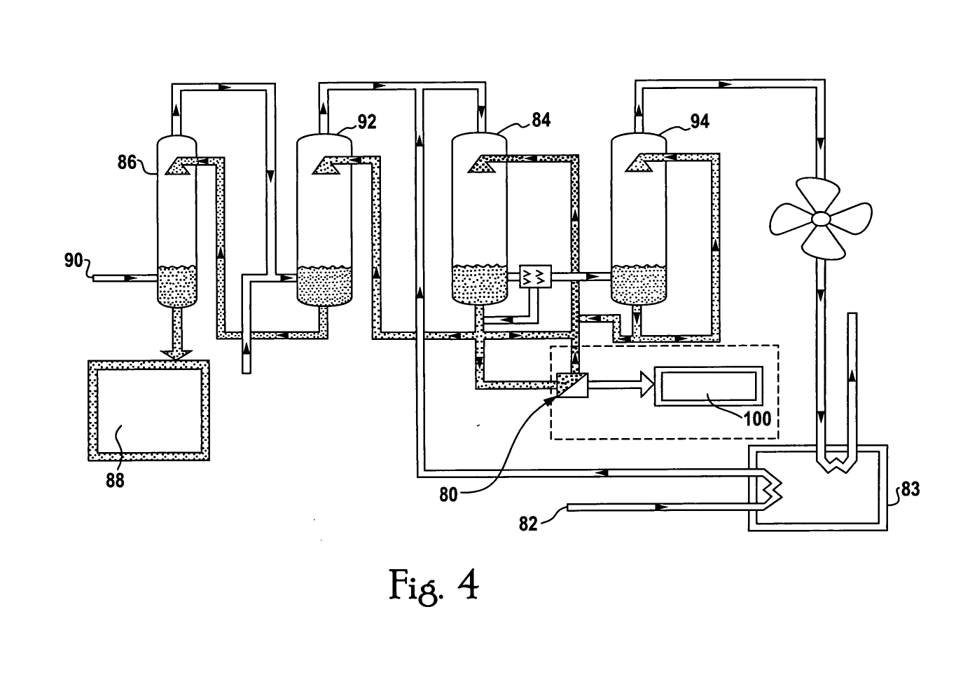

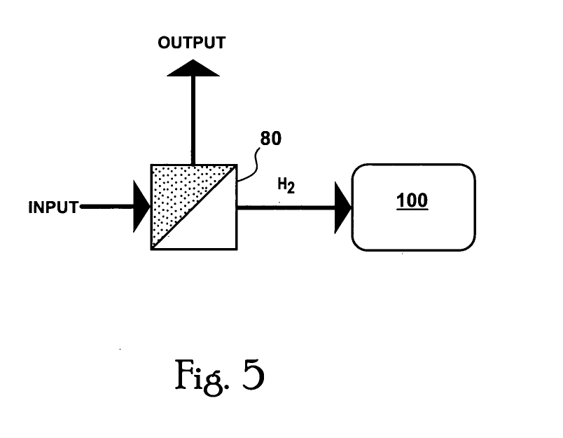

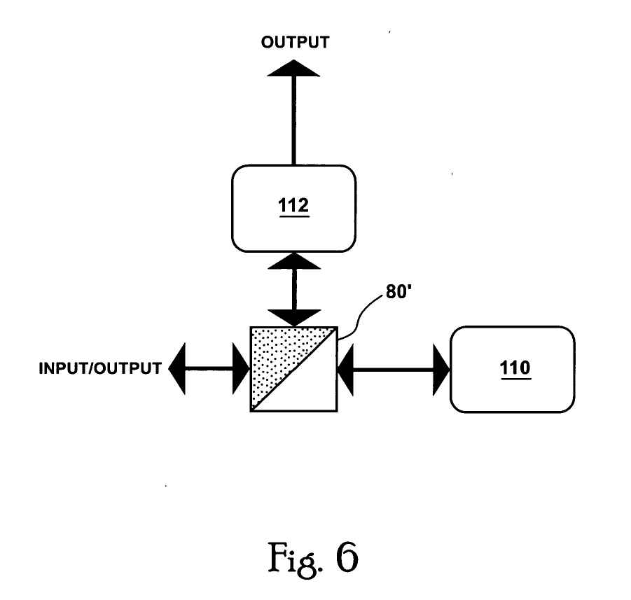

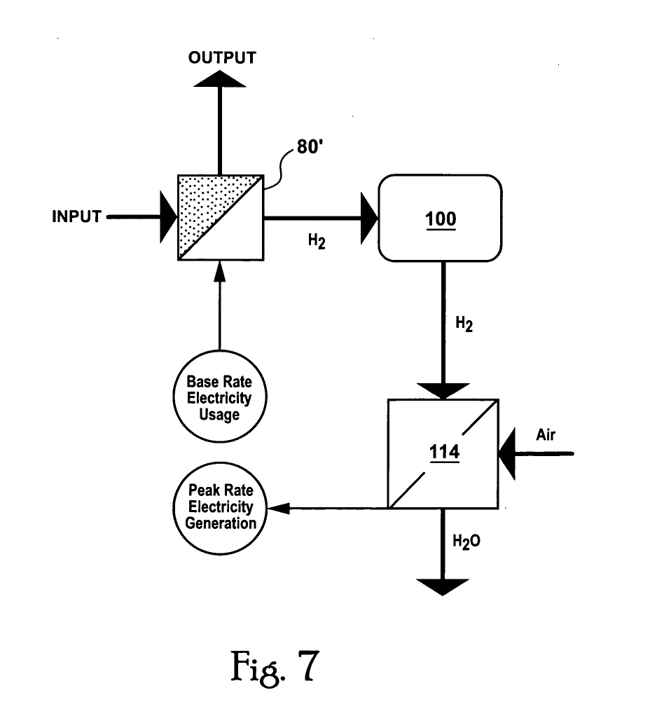

As shown in FIGS. 4 and 5, an example of a flue gas cleaning process uses an electrolizer to reform HBr into H₂ and Br₂ as described above. The H₂ may then be sold and the Br₂ recycled for further use in gas cleaning. In an embodiment of the present invention the electrolyzer is replaced with a reversible HBr fuel cell that, when operated in one direction, can also reform the HBr into H₂ and Br₂, consuming electricity. When operated in the opposite direction, the fuel cell can be used to combine H₂ and Br₂ into HBr, producing electricity. FIGS. 6 and 7 show modifications appropriate for this application. As is readily apparent, this addition may allow a power generation facility to store energy in the form of hydrogen and bromine fuels for the fuel cell. During times of lower demand, excess power capacity is used to generate bromine and hydrogen. During times of higher demand, the cell is run in reverse, providing additional power generation so that peak demands may be met.

Referring now to FIG. 4, the operation of a cleaning apparatus combining the reactors of FIG. 1 with the distiller of FIG. 3 and an electrolyzer 80 is shown. By way of example, specific quantities of gas flows, contaminants, powers and treatment temperatures are described, but those examples are not intended to limit the scope of the claims in any way.

Hot flue gas enters the system at an inlet 82 and is cooled from about 130° C. to about 90° C. in a heat exchanger 83 thereafter flowing into the first reaction chamber 84 at a rate of about 15800 Nm³/h carrying 4.57 g/Nm³ of SO₂ as a contaminant where it is reacted as described above in reference to the reaction chamber 12 shown in FIG. 1. Bromine solution is provided from the electrolyzer 80 to drive the reaction and remove SO₂. As an example, this chamber may be operated at about 65° C. The output fluid of this reactor is directed in part to the second reaction chamber 92, in part to the electrolyzer 80 and in part is re-used within the reaction chamber 84.

A second stream of input gas comes into the second reaction chamber 92 at a rate of about 15800 Nm³/h carrying 4.57 g/Nm³ of SO₂ as a contaminant at an input temperature of about 150° C. This second gas stream is reacted in reactor 92 with a fluid output of the first reaction chamber 84, producing H₂SO₄ for output to a concentration chamber 86 (similar to 40 in FIG. 2) that outputs concentrated H₂SO₄ to storage tank 88 prior to sale or use. For example, this output may be 95% wt. at a rate of 212 kg/h. Optionally, additional hot (300° C.) flue gas at 1560 Nm³/h can be used as an input to the distillation process to provide additional heat.

Flue gas from the reaction chamber 84 passes to a scrubber 94 for acid removal as described above. Note that as described above, the reaction process can include multiple stages, thereby increasing the removal of SO₂ by the process. The scrubbed flue gas is returned at about 50° C. to the heat exchanger 83 before exiting to atmosphere at above 90° C. A fan, 96 can be used to drive the gas through the exchanger 83 and out to atmosphere.

The electrolyzer 80 can output Br and H to a storage device 100 for later use or sale.

As shown in FIG. 5, known electrolyzers 80 can be configured to, using input electricity, produce hydrogen gas which is stored in the storage facility 100. The inputs to this electrolyzer are dilute Br₂, HBr, H₂O, and H₂SO₄ and the outputs are Br₂ for further use in the reactors, dilute HBr, H₂O and H₂SO₄. However, as shown in FIG. 6, the electrolyzer is replaced with a reversible fuel cell 80′. In this case, the storage 100 includes a hydrogen storage tank 110 and a bromine storage tank 112. When desired, hydrogen and bromine are provided back to the fuel cell, producing electricity as well as excess HBr, which can either be returned to the reactor via the input/output, or can be stored in the fuel cell to be electrolyzed later to re-produce the hydrogen and bromine.

An optional improvement would be to add a separate HBr based fuel cell to the retained HBr electrolyser and close couple them, so that the hydrogen and bromine produced by the former (consuming electricity) is immediately consumed by the latter (producing electricity for the electrolyser) without hydrogen or bromine storage. This would have the effect of recovering a portion of the electrical energy from the process as the energy is used to remove the sulfur, thus reducing parasitic loads of the process to the power producing function of the power plant.

Another optional improvement configuration as shown in FIG. 7 retains the HBr electrolyser and adds a hydrogen/air fuel cell 114 and a corresponding hydrogen storage tank 110 for electricity generation. This configuration has the effect of keeping the bromine inventory lower than in the previous configuration and the output of the hydrogen/air fuel cell 114 is high purity water, which can be recycled back into the utility power plant as boiler feed water makeup.

Another optional improvement, not shown, configuration retains the HBr electrolyser and adds hydrogen/air fuel cells without a hydrogen storage tank. The hydrogen produced by the former (consuming electricity) is immediately consumed by the latter (producing electricity for the electrolyser). This would have the effect of recovering a portion of the electrical energy from the process as the energy is used to remove the sulfur, thus reducing parasitic loads of the process to the power producing function of the power plant. This configuration also has the effect of keeping the bromine inventory lower than in the first configuration and the output of the hydrogen/air fuel cells is high purity water, which is recycled back into the utility power plant as boiler feed water makeup.

Another optional improvement configuration, not shown, involves reacting iron and/or aluminum with the co-produced sulfuric acid to produce iron and/or aluminum sulfate and electricity. This has the effect of converting a low value acid byproduct into a valuable fertilizer product, while simultaneously generating electricity to lower parasitic loads of the process to the power producing function of the power plant.

Another optional configuration involves making ammonia from the co-produced hydrogen and air-nitrogen or nitrogen from combustion gasses. The ammonia could also be utilized as a fertilizer to complement the iron sulfate described above, or for other purposes. One other purpose would be to make ammonium sulfate from co-products ammonia and sulfuric acid.

Still another optional configuration involves mercury removal from coal combustion gasses. Because bromine is a strong oxidizing agent, it converts elemental mercury contained in coal (or other fossil fuel) combustion gasses to mercury(II) bromide. This occurs in the reactors described above. As a mercury salt it has no significant vapor pressure and has a higher solubility in water than elemental mercury. Converting mercury to a bromide salt, therefore overcomes the principal barriers to its removal. The mercury(II) bromide is captured in the liquid exiting the reactor, and removed by conventional acid purification methods (distillation). A bromine based flue gas desulfurization process will permit this conversion without any additional processing steps. Because the process would be designed primarily to remove sulfur dioxide, the amount of bromine used for the sulfur removal process will be in far excess of that needed for mercury removal.

Additional embodiments of the invention relate to the treatment of sulfide gases. Typically sulfide containing gases include waste streams in refineries and natural gas treating plants. However, so-called “sour gas,” or natural gas having a high sulfur content, is also a candidate for treatment to remove sulfur and sulfur compounds. In general, such gases are processed through Modified Claus Process sulfur producing plants. About a third of the sulfide gas stream is oxidized by air or oxygen to sulfur dioxide. Then this latter stream is mixed with the remaining two-thirds of the sulfide stream over a catalyst to produce sulfur via the Claus reaction:
SO₂+2H₂S=3S+2H₂O

However, sulfur is not very valuable, and it must be burned to produce the useful sulfuric acid. Moreover, Modified Claus plants are expensive to operate and typically treat only 98% of the sulfide gases, requiring a tail gas unit to remove and treat the remaining sulfide gases.

According to the invention, gases containing sulfide species are contacted in a packed, tray or spray tower with a solution of sulfuric acid, hydrogen bromide and bromine in water. The bromine oxidizes the sulfide species to sulfuric acid and forms hydrogen bromide.
H₂S+4Br₂+4H₂O=H₂SO₄+8HBr

The spent solution is then directed to an electrolytic cell, where a portion, typically but not necessarily 5 to 10%, of the dissolved HBr is electrolyzed to H₂ and Br₂.
8HBr=4H₂+4Br₂

The hydrogen is emitted from the electrolytic cell and is cleaned and stored for sale and/or internal use. The bromine remains in solution as a complex with the bromide ion from the HBr. The regenerated solution containing the complexed bromine is returned to the scrubber. Note that four moles of hydrogen are produced for each mole of hydrogen sulfide. This hydrogen can be beneficially used in a refinery setting to feed hydrotreating, hydrocracking and other hydrogen using unit operations.

A portion of the spent scrubbing solution is periodically or continuously removed and stripped of HBr by heating, e.g., with a stream of hot gas in a packed, tray or spray tower, and the sulfuric acid is sent to storage. The sulfuric acid may be further concentrated, e.g., by evaporation, and sold and/or used internally. Alternatively, it can be employed in the production of other products.

A typical refinery gas stream requiring treatment may have composition as follows:

| | |
|---|---|
| NH₃ | 5.30% |
| CO₂ | 13.03% |
| H₂S | 73.35% |
| H₂O | 7.95% |
| Hydrocarbons | 0.37% |
| Total | 100.00% |

In this case, the NH₃ (ammonia) may be removed from the waste gas prior to treatment with bromine by first scrubbing the waste gas in a packed, tray or spray tower with a portion of the product sulfuric acid.
2NH₃+H₂SO₄=(NH₄)₂SO₄
The (NH₄)₂SO₄, a useful fertilizer ingredient, can be sold as a solution or can be crystallized for sale.

After removal of ammonia, the waste gas contains CO₂, H₂S, H₂O and hydrocarbons (primarily methane). Substantially all of the H₂S is removed from this stream by the bromine reaction. The remaining gas consisting of CO₂, H₂O and hydrocarbons is directed to a flare. If there is carryover of a small amount of bromine in this gas, it can be removed by adding a packed section, a tray or a spray section to the bromine reaction tower or as a separate tower. A small amount of sulfur dioxide then could be added to a water solution to react with the Br₂ to produce HBr and sulfuric acid. The latter solution can be added back into the reactor scrubbing solution.

In alternate, embodiment, bromine from the system may be used in a solar reactor for production of hydrogen. In this embodiment, water and bromine are reacted in a gaseous state with the energy required for the reaction being provided by the sun. A chamber is provided to contain the water and bromine (and/or other halogens such as chlorine and iodine). The chamber is heated by solar energy, dissociating halogen molecules. The halogen atoms reform molecules exothermically, and the energy released can be used to heat an inert buffer gas such as argon or helium, raising the temperature to temperatures above 1700° C. By reacting water with bromine in the chamber, hydrogen bromide and oxygen are produced. The hydrogen bromide can then be electrolyzed to produce hydrogen and bromine and the hydrogen can be sold or used and the bromine can be re-used in the solar reactor.

Although the embodiments of the invention have been described above with respect to the use of bromine and bromine compounds, in alternative embodiments, other halogens, such as chlorine and iodine, may be used. Additionally, it is possible to use fluorine, although the use of fluorine may require special handling.

It should now be apparent that the comprehensive system for utility load leveling, hydrogen production, and stack gas cleanup, as described hereinabove, possesses each of the attributes set forth in the specification above. Because it can be modified to some extent without departing from the principles thereof as they have been outlined and explained in this specification, the present invention should be understood as encompassing all such modifications as are within the spirit and scope of the following claims.

1. An apparatus comprising:
a reactor having a chamber wherein a reactant can be mixed with an input fluid to be treated such that sulfur compounds in the input fluid form sulfuric acid and atoms of the reactant form compounds with hydrogen; and
a reversible fuel cell coupled to an output of the reactor to receive an output comprising the hydrogen compounds, the fuel cell being constructed and arranged to use electricity to selectively split the hydrogen compounds to produce hydrogen and reactant therefrom or to generate electricity by combining hydrogen and reactant atoms to produce hydrogen compounds.

2. An apparatus as in claim 1, wherein the fluid is at least one of a gas, a liquid, a solid suspension, and a mixture thereof.

3. An apparatus as in claim 1, wherein the reactant is a halogen.

4. An apparatus as in claim 3, wherein the reactant is bromine.

5. An apparatus as in claim 4, wherein the reversible fuel cell is a hydrogen bromide fuel cell.

6. An apparatus as in claim 1, wherein the input fluid comprises stack gas from a hydrocarbon burning power plant.

7. An apparatus as in claim 1, wherein the input fluid comprises sulfur-containing natural gas.

8. An apparatus as in claim 1, wherein the input fluid comprises a sulfide-containing waste gas from a refinery or a natural gas treatment plant.

9. An apparatus according to claim 1 further comprising a solar reactor in which water and bromine from the reactant are reacted, the reacting comprising heating by solar energy to produce HBr and oxygen.

10. An apparatus comprising:
at least one reactor constructed and adapted to carry out a reaction of the form X₂+SO₂+H₂O=>HX+H₂SO₄, where X is a halogen;
an HX electrolyzer in fluid communication with the at least one reactor to receive an output stream therefrom; and
a hydrogen/oxygen fuel cell in fluid communication with the HX electrolyzer, such that during operation, hydrogen from the HX electrolyzer is used to fuel the hydrogen/oxygen fuel cell for power generation thereby.

11. An apparatus according to claim 10 wherein the halogen is bromine and the HX electrolyzer is a HBr electrolyzer.

12. An apparatus according to claim 10 further comprising:
a distiller, constructed and arranged to distill the sulfuric acid to produce concentrated sulfuric acid.

13. An apparatus comprising:
a reactor having a chamber wherein a reactant can be mixed with an input fluid to be treated such that sulfur compounds in the input fluid form sulfuric acid and atoms of the reactant form compounds with hydrogen;
an electrolyzer constructed and arranged to process the hydrogen compounds to produce hydrogen;
a hydrogen/oxygen fuel cell, in fluid communication with the electrolyzer to receive the produced hydrogen and constructed and arranged to combine the produced hydrogen with oxygen to form water.

14. An apparatus according to claim 13 wherein power produced by the hydrogen/oxygen fuel cell is used to power the electrolyzer.

15. A method comprising:
supplying a halogen reactant to a reaction chamber;
supplying an input fluid comprising sulfur compounds;
reacting the reactant with the input fluid to form sulfuric acid and HX, where X is a halogen;
supplying the HX to a reversible fuel cell; and
selectively running the reversible fuel cell in a first direction to produce hydrogen and consume electricity and in a second direction to consume hydrogen and produce electricity.

16. A method as in claim 15 wherein the halogen is bromine and the input fluid comprises SO₂.

17. A method as in claim 16 wherein the input fluid is selected from the group comprising natural gas, power plant stack gas, natural gas treatment plant waste gas, and refinery waste gas.

18. A method as in claim 15, further comprising:
determining peak and reduced demand operating times;
during reduced demand operating times, running the reversible fuel cell in the first direction and storing the produced hydrogen; and
during peak demand operating times, running the reversible fuel cell in the second direction to produce electricity.

19. A method comprising:
supplying a halogen reactant to a reaction chamber;
supplying an input fluid comprising sulfur compounds;
reacting the reactant with the input fluid to form sulfuric acid and HX, where X is a halogen;
supplying the HX to a HX electrolyzer;
supplying hydrogen from the HX electrolyzer to a hydrogen/oxygen fuel cell; and
operating the hydrogen/oxygen fuel cell to produce water and electricity.

20. A method as in claim 19 further comprising storing the hydrogen from the HX electrolyzer such that the operating the hydrogen/oxygen fuel cell may be performed selectively in response to changes in power demand.

21. A method comprising:
supplying a halogen reactant to a reaction chamber;
supplying an input fluid comprising sulfur compounds;
reacting the reactant with the input fluid to form sulfuric acid; and
reacting iron and/or aluminum with the sulfuric acid to produce iron and/or aluminum sulfate and electricity.

22. A method comprising:
supplying a halogen reactant to a reaction chamber;
supplying an input fluid comprising sulfur compounds;
reacting the reactant with the input fluid to form sulfuric acid and HX, where X is a halogen;
electrolyzing the HX to produce hydrogen; and
reacting the hydrogen with nitrogen to produce ammonia.

23. A method as in claim 22 wherein the nitrogen is a component of air or of combustion gases.

24. A method comprising:
supplying bromine to a reaction chamber;
supplying an input fluid comprising sulfur compounds and elemental mercury;
reacting the bromine with the input fluid to form sulfuric acid and HBr;
reacting the bromine with the elemental mercury to produce mercury bromide; and
capturing the mercury bromide for disposal.
